(19) United States
(12) Patent Application Publication
(10) Pub. No.: US 2004/0151062 A1
(43) Pub. Date: Aug. 5, 2004

(54) Automatic chemical mixing system

(75) Inventors: Jen-Feng Yao, Yungkang City (JP); Shin-Shing Yang, Yungkang City (TW); Yu-Sen Chang, Tainan (TW); Liang-Yi Chou, Yungkang City (TW); Jenn-Wei Ju, Taiping City (TW); Ping Lu, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/356,258

(22) Filed: Jan. 30, 2003

(51) Int. Cl. B01F 15/02

(52) U.S. Cl. 366/137; 366/153.1

(57) ABSTRACT

A novel interlocked automatic chemical mixing system and method of use which is particularly well-suited to preparing a final diluted HF (hydrofluoric acid) mixture of desired concentration for the post-cleaning rinsing of semiconductor wafer substrates. The automatic chemical mixing system includes a mixing tank having a normal level sensor and a mixing level sensor above the normal level sensor. A mixing system is provided for thoroughly mixing the liquid precursor components in the mixing tank. In typical application, DI water is introduced into the mixing tank until the DI water reaches the level of the mixing sensor. The precursor aqueous HF is then introduced into the mixing tank until the level of the HF reaches the normal level sensor.

### FIELD OF THE INVENTION

The present invention relates to apparatus for mixing precursor chemicals to obtain a final chemical mixture having selected ratios or percentages of the precursor chemicals. More particularly, the present invention relates to an automatic chemical mixing system for mixing liquid chemical precursors in selected ratios to obtain a final liquid mixture, particularly for use in semiconductor wafer processing.

### BACKGROUND OF THE INVENTION

Generally, the process for manufacturing integrated circuits on a silicon wafer substrate typically involves deposition of a thin dielectric or conductive film on the wafer using oxidation or any of a variety of chemical vapor deposition processes; formation of a circuit pattern on a layer of photoresist material by photolithography; placing a photoresist mask layer corresponding to the circuit pattern on the wafer; etching of the circuit pattern in the conductive layer on the wafer; and stripping of the photoresist mask layer from the wafer. Each of these steps, particularly the photoresist stripping step, provides abundant opportunity for organic, metal and other potential circuit-contaminating particles to accumulate on the wafer surface.

In the semiconductor fabrication industry, minimization of particle contamination on semiconductor wafers increases in importance as the integrated circuit devices on the wafers decrease in size. With the reduced size of the devices, a contaminant having a particular size occupies a relatively larger percentage of the available space for circuit elements on the wafer as compared to wafers containing the larger devices of the past. Moreover, the presence of particles in the integrated circuits compromises the functional integrity of the devices in the finished electronic product. Currently, mini-environment based IC manufacturing facilities are equipped to control airborne particles much smaller than 1.0 μm, as surface contamination continues to be of high priority to semiconductor manufacturers. To achieve an ultra clean wafer surface, particles must be removed from the wafer, and particle-removing methods are therefore of utmost importance in the fabrication of semiconductors. Cleaning the surface of a wafer is particularly important prior to the growth of a thermal oxidation layer on a wafer, since ultra thin oxide layers must start with a completely clean wafer surface area.

The most common system for cleaning semiconductor wafers during wafer processing includes a series of tanks which contain the necessary cleaning solutions and are positioned in a “wet bench” in a clean room. Batches of wafers are moved in sequence through the tanks, typically by operation of a computer-controlled automated apparatus. Currently, semiconductor manufacturers use wet cleaning processes which may use cleaning agents such as deionized water and/or surfactants. Other wafer-cleaning processes utilize solvents, dry cleaning using high-velocity gas jets, and a megasonic cleaning process, in which very high-frequency sound waves are used to dislodge particles from the wafer surface. Cleaning systems which use deionized (DI) water currently are widely used in the industry because the systems are effective in removing particles from the wafers and are relatively cost-efficient. Approximately 4.5 tons of water are used for the production of each 200-mm, 16-Mbit, DRAM wafer.

The most widely used process for the wet-cleaning of wafers is the RCA clean process, which includes sequential immersion in two different chemical baths known as Standard Clean 1 (SC-1) and Standard Clean 2 (SC-2). SC-1 uses an alkaline solution including ammonium hydroxide, hydrogen peroxide and DI water and is capable of removing particles and organic materials from the surface of the wafer. SC-2 uses an acidic solution including hydrochloric acid, hydrogen peroxide and DI water and is capable of removing metals from the surface of the wafer. Over time, modifications to the RCA process have been made to save the high volumes of process chemicals and ultrapure water which are characteristic of the original process. For example, dilute cleaning chemistries that utilize the original chemical components in up to 100 times more dilute concentrations are currently in widespread use to both improve the safety and health of facility personnel as well as reduce chemical usage and disposal. The RCA wet-clean process continues to be widely used due to the availability of ultrapure water and chemicals.

Another mixture commonly used to remove organic and metallic impurities from a wafer surface is the Pirhana mixture, which combines sulfuric acid and hydrogen peroxide. The Pirhana composition is used at different steps in the cleaning process, such as prior to the SC-1 and SC-2 cleaning steps of the RCA-process. Typically, the wafers are immersed in the solution at 125 degrees C for about 19 minutes, followed by a thorough DI-water rinse.

Frequently, hydrofluoric acid (HF), diluted in deionized (DI) water, is applied to the wafer surface in a final step after the other cleaning steps are completed. Fluoride-containing chemistries are also used to clean prime semiconductor wafers, or wafers which have not yet undergone ion implantation or device fabrication. The HF removes native oxides from the wafer surface. As a result of the exposure to HF, the wafer surface is completely terminated with hydrogen atoms and is highly resistant to re-oxidation in air. HF-dispensing steps may be carried out in a SEZ spin wet cleaning tool available from Semiconductor Equipment Zubehor (SEZ) of Villach, Austria, for example.

In the HF-rinsing step of wafer cleaning, the concentration of aqueous HF applied to the wafer is important for adequate removal of oxides from the wafer. The aqueous HF may be supplied to the SEZ tool from a Fab facility supply system at a predetermined and non-adjustable concentration, such as about 24.5%, which is less than optimal for the HF rinsing step. Currently, the HF rinsing step requires an aqueous HF solution which contains a concentration of typically about 49% HF in DI water. Accordingly, a chemical mixing system which is suitable for mixing the aqueous HF and DI water in proper ratios to obtain a diluted HF mixture for optimum HF rinsing, is needed.

It is therefore an object of the present invention to provide a novel chemical mixing system which is suitable for mixing two or more components of a mixture in selected ratios.

Another object of the present invention is to provide a novel interlocked chemical mixing system which may be adapted to automatically mix two or more liquid precursor components of a mixture in selected ratios to obtain a final liquid mixture.

Still another object of the present invention is to provide a novel automatic chemical mixing system which is capable of mixing aqueous HF of selected concentration with DI water to prepare a diluted HF solution for the rinsing of semiconductor wafer substrates.

Yet another object of the present invention is to provide a novel automatic chemical mixing system which is suitable for mixing a variety of liquids for various purposes.

A still further object of the present invention is to provide a novel interlocked automatic chemical mixing system which utilizes a mixing tank for receiving the precursor liquid chemicals, multiple liquid level sensors for automatically stopping the introduction of the chemicals into the mixing tank, and a mixing system for mixing the chemicals and achieving a desired mixture of the chemicals in the mixing tank.

Still another object of the present invention is to provide an interlocked automatic chemical mixing system for obtaining a final liquid mixture having components of selected percentages or ratios by providing precursor components of selected concentration or percentage in a mixing tank and mixing the precursor components to obtain the final mixture.

Yet another object of the present invention is to provide an interlocked automatic chemical mixing system which utilizes multiple, vertically-spaced level sensors on a mixing tank to facilitate obtaining a final liquid mixture by filling the tank with a first liquid component to one of the sensors, filling the tank with a second liquid component to the next highest sensor, and then mixing the components to obtain a final mixture having a selected percentage of the first and second liquid components.

A still further object of the present invention is to provide a method of obtaining a final liquid mixture which contains first and second precursor components each having a selected composition concentration or percentage, including the steps of providing a mixing tank having multiple, vertically-spaced liquid level sensors; filling the tank with the first liquid precursor component to one of the sensors; filling the tank with the second liquid precursor component to the next highest sensor; and then mixing the components to obtain a final mixture having a selected percentage or ratio of the first and second liquid precursor components.

### SUMMARY OF THE INVENTION

In accordance with these and other objects and advantages, the present invention is generally directed to a novel interlocked automatic chemical mixing system and method of use which is particularly well-suited to preparing a final diluted HF (hydrofluoric acid) mixture of desired concentration for the post-cleaning rinsing of semiconductor wafer substrates. The automatic chemical mixing system includes a mixing tank having a normal level sensor and a mixing level sensor above the normal level sensor. A mixing system is provided for thoroughly mixing the liquid precursor components in the mixing tank. In typical application, DI water is introduced into the mixing tank until the DI water reaches the level of the mixing sensor. The precursor aqueous HF is then introduced into the mixing tank until the level of the HF reaches the normal level sensor. Finally, the mixing system thoroughly mixes the DI water and the aqueous HF in the mixing tank to prepare a final diluted HF mixture in preparation for rinsing the substrates with the diluted HF, for example. Depending on the concentration of the precursor aqueous HF, various concentrations of the diluted HF may be obtained. Various liquid components other than DI water and aqueous HF may be mixed in the mixing tank to obtain a final liquid mixture having a selected percentage or ratio of the precursor liquid components.

The mixing system may include a recirculation mixing loop which pumps the liquid components to be mixed from the mixing tank and back into the mixing tank. A filter may be provided in the recirculation mixing loop for filtering particles from the liquids. Alternative mechanisms known by those skilled in the art for mixing the liquid components in the tank may be used.

### BRIEF DESCRIPTION OF THE DRAWINGS

The invention will now be described, by way of example, with reference to the accompanying drawings, in which:

FIG. 1 is a schematic view of an illustrative embodiment of the automatic chemical mixing system of the present invention;

FIG. 2A is a schematic illustrating initial introduction of a first liquid into the mixing tank of the present invention as a first step in typical application of the invention;

FIG. 2B is a schematic illustrating introduction of a second liquid into the mixing tank of the present invention as a second step in typical application of the invention; and

FIG. 2C is a schematic illustrating mixing of the first and second liquids by operation of a re-circulation mixing loop as a third step in typical application of the invention.

### DESCRIPTION OF THE PREFERRED EMBODIMENTS

The present invention has particularly beneficial utility in the preparation of a diluted HF (hydrofluoric acid) mixture for the rinsing of semiconductor wafer substrates with the diluted HF, such as after an RCA wafer clean process is carried out on the substrates, for example. However, the invention is not so limited in application, and while references may be made to such diluted HF and semiconductor wafer substrates, it is understood that the present invention is more generally applicable to obtaining a final liquid mixture by mixing precursor liquid chemicals in a variety of industrial and mechanical applications.

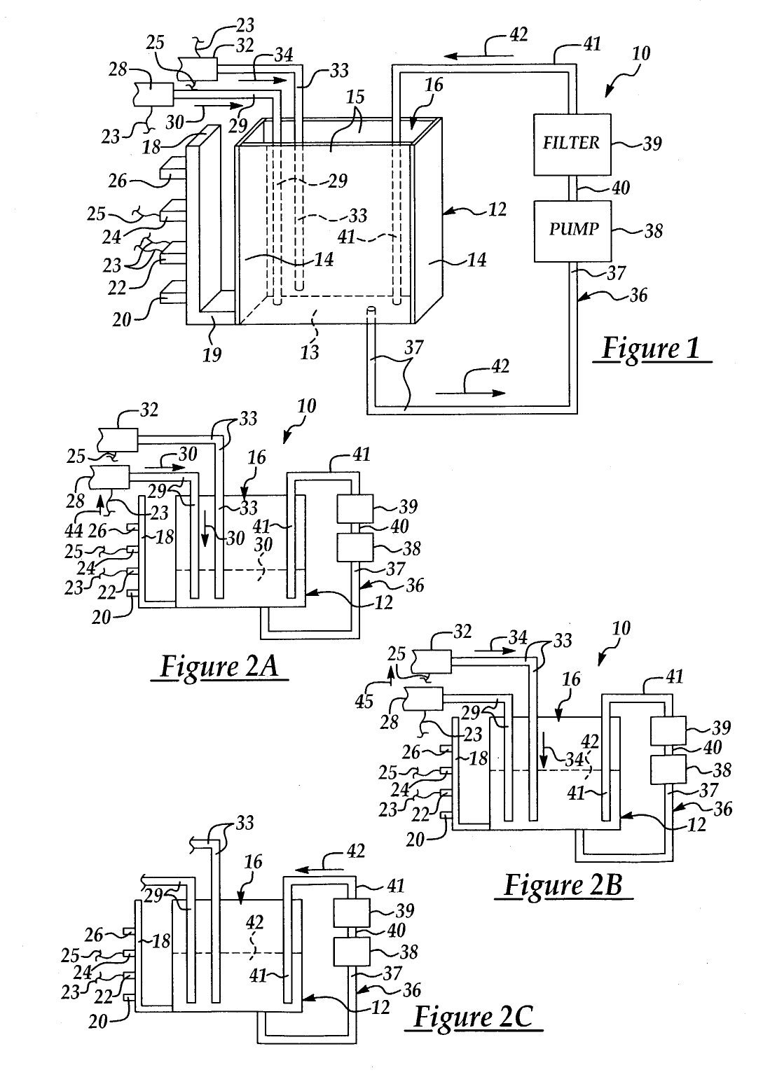

Referring initially to FIG. 1, an illustrative embodiment of the automatic chemical mixing system 10 of the present invention includes a mixing tank 12, typically having a bottom panel 13, end panels 14, and side panels 15 spanning the end panels 14, defining a tank interior 16. A level sensor support 18 is connected to one of the end panels 14 typically through a connector 19. A low liquid level sensor 20 and a normal liquid level sensor 24 are provided on the level sensor support 18, with the low liquid level sensor 20 located just above the bottom panel 13 of the mixing tank 12. A mixing liquid level sensor 22 is provided on the level sensor support 18, typically substantially equidistant between the low liquid level sensor 20 and the normal liquid level sensor 24. An alarm liquid level sensor 26 is typically further provided on the level sensor support 18, above the normal liquid level sensor 24. The low liquid level sensor 20, the mixing liquid level sensor 22, the normal liquid level sensor 24 and the alarm liquid level sensor 26 may be any type of liquid level sensor known by those skilled in the art and suitably adapted for sensing respective levels of a liquid or liquids in the mixing tank 12, and may be conventional. The sensors 20, 22, 24 and 26 may alternatively be provided on the end panel 14 or on one of the side panels 15 of the mixing tank 12, in which case the level sensor support 18 may be omitted, as desired, or in any other location which facilitates their sensing of the respective levels of the liquids in the mixing tank 12.

One end of a DI water conduit 29 is confluently connected to a DI water pump and supply mechanism 28 which contains a supply of DI water 30. The opposite end of the DI water conduit 29 is positioned in the tank interior 16, near the bottom panel 13 of the mixing tank 12. In similar fashion, one end of an HF conduit 33 is confluently connected to an HF pump and supply mechanism 32 which contains a supply of aqueous HF 34 of selected concentration. The opposite end of the HF conduit 33 is positioned in the tank interior 16, near the bottom panel 13 of the mixing tank 12. Wiring 23 connects the mixing liquid level sensor 22 to the pumping component (not shown) of the DI water supply 28 and to the pumping component (not shown) of the HF pump and supply mechanism 32. Similarly, wiring 25 connects the normal liquid level sensor 24 to the pumping component (not shown) of the HF supply 32. The normal liquid level sensor 24 may be further operably connected to the pump 38 of a recirculation mixing loop 36, which will be hereinafter described. Accordingly, the mixing liquid level sensor 22 is capable of terminating operation of the DI water pump and supply mechanism 28 and initiating operation of the HF pump and supply mechanism 32 when the level of the DI water 30 in the mixing tank 12 reaches the mixing liquid level sensor 22. In similar fashion, the normal liquid level sensor 24 is capable of terminating operation of the HF pump and supply mechanism 32 and initiating operation of the pump 38 of the recirculation mixing loop 36 as the HF 34 is added to the mixing tank 12 and the level of the HF 34 and DI water 30 in the mixing tank 12 reaches the normal liquid level sensor 24, as hereinafter described.

The automatic chemical mixing system 10 typically further includes a recirculation mixing loop 36 for mixing the diluted HF 42 (FIG. 2B) after both the DI water 30 and the aqueous HF have been added to the mixing tank 12, as hereinafter described. The recirculation mixing loop 36 includes an outlet conduit 37 which extends from the bottom panel 13 of the mixing tank 12, in confluent communication with the tank interior 16. A pump 38 is provided in the outlet conduit 37, and a filter 39 may be connected to the outlet of the pump 38 through a connecting conduit 40. A return conduit 41 extends from the outlet of the filter 39 and terminates in the bottom portion of the tank interior 16, adjacent to the bottom panel 13. Accordingly, by operation of the pump 38, liquid is drawn from the tank interior 16 through the outlet conduit 37, the pump 38, the connecting conduit 40, the filter 39, and back into the tank interior 16 through the return conduit 41. In this manner, the liquid components separately added to the tank interior 16 in preceding steps are thoroughly mixed to provide a substantially homogenous liquid mixture, as hereinafter described. It is understood that various other mechanisms known by those skilled in the art for mixing the liquid components in the tank interior 16 may be used as an alternative to the recirculation mixing loop 36, as desired.

Referring next to FIGS. 2A-2C, in typical application the automatic chemical mixing system 10 is used to thoroughly mix DI water 30 with precursor aqueous HF 34 of selected concentration or percentage in order to obtain a final diluted HF 42 having a selected concentration or percentage. The diluted HF 42 is then distributed to a process chamber (not shown) such as a SEZ wet spin cleaner to rinse a substrate (not shown) in the cleaner, for example, after the substrate is subjected to an RCA rinsing process. Accordingly, DI water 30 is initially pumped from the DI water pump and supply mechanism 28 through the DI water conduit 29 and into the tank interior 16 until the level of the DI water 30 rises to the level of the mixing liquid level sensor 22, as shown in FIG. 2A. At that point, the mixing liquid level sensor 22 terminates operation of the DI water pump and supply mechanism 28, by sending a termination signal 44 through the wiring 23, to prevent further flow of the DI water 30 into the tank interior 16. Next, the HF pump and supply mechanism 32 pumps aqueous HF 34 into the tank interior 16 through the HF conduit 33, until the diluted HF 42, which includes both the DI water 30 and the aqueous HF 34, reaches the level of the normal liquid level sensor 24, as shown in FIG. 2B. At that point, the normal liquid level sensor 24 terminates operation of the HF pump and supply mechanism 32, by sending a termination signal 45 through the wiring 25, to prevent further flow of the aqueous HF 34 into the tank interior 16. Accordingly, the DI water 30 and the aqueous HF 34 are present in substantially equal volumes in the tank interior 18 in the embodiment of the system 10 in which the mixing liquid level sensor 22 is located equidistant or midway between the low liquid level sensor 20 and the alarm liquid level sensor 26. However, it is understood that the mixing liquid level sensor 22 may be positioned at any desired location between the low liquid level sensor 20 and the normal liquid level sensor 24 to facilitate the placement of corresponding relative volumes of the DI water 30 and the aqueous HF 34 in the tank interior 16.

Finally, as shown in FIG. 2C, the DI water 30 and the aqueous HF 34 in the diluted HF 42 are thoroughly mixed to substantially homogenize the diluted HF 42. This is accomplished by operation of the pump 38 of the recirculation mixing loop 36, in which the diluted HF 42 is drawn from the tank interior 16, through the outlet conduit 37, the pump 38, the connecting conduit 40, the return conduit 41 and back into the tank interior 16, respectively. As the diluted HF 42 is drawn through the filter 39, particles (not shown) which may contaminate the diluted HF are removed therefrom. This recirculation step is carried out for a time period of typically about 5 minutes, after which the pump 38 is turned off and the diluted HF 42 in the tank interior 16 is thoroughly mixed and substantially homogenous. Finally, the diluted HF 42 is drawn from the tank interior 16 to the process tool, according to the knowledge of those skilled in the art. In the process tool, the diluted HF 42 may be used to rinse the substrate (not shown) typically having been previously subjected to a multi-step RCA rinsing process, for example.

In the event that the normal liquid level sensor 24 malfunctions and the diluted HF 42 rises in the tank interior 16 to the level of the alarm liquid level sensor 26, the alarm liquid level sensor 26 may activate an alarm (not shown) or may terminate operation of the DI water pump and supply mechanism 28, the HF pump and supply mechanism 32, or both, to prevent overflow of the diluted HF 42 from the mixing tank 12. Conversely, in the event that the diluted HF 42 drops beneath the level of the low liquid level sensor 20, the low liquid level sensor 20 may activate an alarm (not shown) or initiate operation of the DI water pump and supply mechanism 28 to begin preparation of another batch of the diluted HF 42.

For the embodiment of the system 10 described herein above, in which the mixing liquid level sensor 22 is located equidistant between the low liquid level sensor 20 and the normal liquid level sensor 26, substantially equal volumes of the DI water 30 and the aqueous HF 34 are mixed together to define the diluted HF 42. Depending upon the concentration of the precursor aqueous HF 34, the final diluted HF 42 prepared according to the method described above may be any desired concentration between about 1% and about 50%, depending upon the intended application for the final diluted HF 42. For example, to achieve a final diluted HF 42 of 25% concentration, the DI water 30 is mixed with a precursor aqueous HF 34 of equal volume and having a concentration of 50%. To achieve a final diluted HF 42 of 49% concentration, the DI water 30 is mixed with a precursor aqueous HF 34 of equal volume and having a concentration of 98%. Concentrations of the diluted HF greater than 50% are possible in embodiments in which the mixing liquid level sensor 22 is located closer to the low liquid level sensor 20 than to the normal liquid level sensor 24, in which a greater volume of the aqueous HF 34 as compared to the volume of the DI water 30 is poured in the tank interior 16 by operation of the HF pump and supply mechanism 32 and the DI water pump and supply mechanism 28, respectively, for mixing.

While the preferred embodiments of the invention have been described above, it will be recognized and understood that various modifications can be made in the invention and the appended claims are intended to cover all such modifications which may fall within the spirit and scope of the invention.

What is claimed is:

1. A chemical mixing system comprising:
a mixing tank for receiving first and second liquids;
a mixing liquid level sensor operably engaging said tank for terminating flow of the first liquid into said mixing tank at a first liquid level;
a normal liquid level sensor operably engaging said tank for terminating flow of the second liquid into said mixing tank at a second liquid level above said first liquid level; and
a mixing mechanism for mixing the first and second liquids in said mixing tank.

2. The chemical mixing system of claim 1 further comprising a low liquid level sensor operably engaging said mixing tank for sensing a low liquid level below said first liquid level in said mixing tank.

3. The chemical mixing system of claim 1 further comprising an alarm liquid level sensor operably engaging said mixing tank for sensing a high liquid level above said second liquid level in said mixing tank.

4. The chemical mixing system of claim 3 further comprising a low liquid level sensor operably engaging said mixing tank for sensing a low liquid level below said first liquid level in said mixing tank.

5. The chemical mixing system of claim 1 wherein said mixing mechanism comprises a recirculation mixing loop comprising an outlet conduit confluently engaging said mixing tank, a pump confluently engaging said outlet conduit and a return conduit confluently engaging said pump and said mixing tank for circulating the first and second liquids from said mixing tank, through said recirculation mixing loop and to said mixing tank, respectively.

6. The chemical mixing system of claim 5 further comprising a low liquid level sensor operably engaging said mixing tank for sensing a low liquid level below said first liquid level in said mixing tank.

7. The chemical mixing system of claim 5 further comprising an alarm liquid level sensor operably engaging said mixing tank for sensing a high liquid level above said second liquid level in said mixing tank.

8. The chemical mixing system of claim 7 further comprising a low liquid level sensor operably engaging said mixing tank for sensing a low liquid level below said first liquid level in said mixing tank.

9. The chemical mixing system of claim 5 further comprising a particle filter provided in confluent communication with said pump for filtering particles from the first and second liquids.

10. The chemical mixing system of claim 9 further comprising a low liquid level sensor operably engaging said mixing tank for sensing a low liquid level below said first liquid level in said mixing tank.

11. The chemical mixing system of claim 9 further comprising an alarm liquid level sensor operably engaging said mixing tank for sensing a high liquid level above said second liquid level in said mixing tank.

12. The chemical mixing system of claim 11 further comprising a low liquid level sensor operably engaging said mixing tank for sensing a low liquid level below said first liquid level in said mixing tank.

13. A chemical mixing system for mixing liquids, comprising:
a mixing tank;
first and second supply conduits confluently associated with said mixing tank for dispensing first and second liquids, respectively, into said mixing tank;
a mixing liquid level sensor operably engaging said tank for terminating flow of the first liquid into said mixing tank at a first liquid level;
a normal liquid level sensor operably engaging said tank for terminating flow of the second liquid into said mixing tank at a second liquid level above said first liquid level; and
a mixing mechanism for mixing the first and second liquids in said mixing tank.

14. The chemical mixing system of claim 13 further comprising a low liquid level sensor operably engaging said mixing tank for sensing a low liquid level below said first liquid level in said mixing tank.

15. The chemical mixing system of claim 13 further comprising an alarm liquid level sensor operably engaging said mixing tank for sensing a high liquid level above said second liquid level in said mixing tank.

16. The chemical mixing system of claim 13 wherein said mixing mechanism comprises a recirculation mixing loop comprising an outlet conduit confluently engaging said mixing tank, a pump confluently engaging said outlet conduit and a return conduit confluently engaging said pump and said mixing tank for circulating the first and second liquids from said mixing tank, through said recirculation mixing loop and to said mixing tank, respectively.

17. The chemical mixing system of claim 16 further comprising a particle filter provided in confluent communication with said pump for filtering particles from the first and second liquids.

18. A method of preparing a final liquid mixture by mixing a first liquid with a second liquid, comprising the steps of:
providing a mixing tank;
providing a mixing liquid level sensor for sensing a first liquid level in said mixing tank;
providing a normal liquid level sensor for sensing a second liquid level in said mixing tank above said first liquid level;
placing the first liquid in said mixing tank until the first liquid reaches said first liquid level;
placing the second liquid in said mixing tank until the second liquid reaches said second liquid level; and
mixing the first liquid and the second liquid in said mixing tank to define the final liquid mixture.

19. The method of claim 18 further comprising the steps of providing a first liquid pump and supply mechanism and a second liquid pump and supply mechanism in confluent association with said mixing tank for said placing the first liquid in said mixing tank and placing the second liquid in said mixing tank, respectively; terminating placement of the first liquid into said mixing tank when the first liquid reaches the mixing liquid level sensor by transmitting a first termination signal from said mixing liquid level sensor to said first liquid pump and supply mechanism; and terminating placement of the second liquid into said mixing tank when the second liquid reaches the normal liquid level sensor by transmitting a second termination signal from said normal liquid level sensor to said second liquid pump and supply mechanism.

20. The method of claim 18 wherein said mixing the first liquid and the second liquid in said mixing tank to define the final liquid mixture comprises the steps of providing a recirculation mixing loop having a pump in confluent association with said mixing tank and pumping the first and second liquids from said mixing tank, through said recirculation mixing loop and back into said mixing tank, respectively.
